(19) United States
(12) Patent Application Publication
(10) Pub. No.: US 2004/0051787 A1
(43) Pub. Date: Mar. 18, 2004

(54) Camera system

(76) Inventors: Yasuo Mutsuro, Yokohama (JP); Shinichi Nonaka, Chigasaki (JP); Mayuko Tanaka, Yokohama (JP); Masayuki Hamajima, Shiroi (JP); Kinsing Kwok, Yamanakako (JP); Masatomo Fujiwara, Matsudo (JP); Kazuyoshi Miyazawa, Matsudo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/618,749

(22) Filed: Jul. 15, 2003

(30) Foreign Application Priority Data
Aug. 30, 2002 (JP) 2002-252341

(51) Int. Cl. H04N 5/232

(52) U.S. Cl. 348/211.99

(57) ABSTRACT

As the number of pixels in a digital camera is increased, the power consumption is increased due to an increased quantity of data to be photographed, which inevitably requires a large capacity of battery and an increased camera weight. In order to enhance a picture quality, an optical system is also required to have a larger scale, with the result that the casing of the camera becomes large. In facilities such as an amusement part, since the user carries the camera for a long time, the heavy, large-sized camera becomes cumbersome to deal with. The camera is installed at a photographing spot in the facilities, the camera is provided with a means for performing wireless communication with a portable device carried by the user, and photographed image data is saved in a recording medium of the portable device or in a server connected between the camera and a network.

### BACKGROUND OF THE INVENTION

The present invention relates to a camera system wherein an image pick-up means and an operating means are provided as separated.

One of prior arts in the present technical field is disclosed, for example, in JP-A-2000-023015. Cited in this Publication is that “the object of the present invention is to provide an electronic camera system which can be used in common by may users, simplifies photographing and also easily control the image information by every user”. In the Publication, the above object is attained as follows. That is, “A camera device is placed at a prescribed position and also plural remote controllers are prepared to supply photographing start signals to the device. The individual identification codes are allocated to the controllers, and an ID information transmitting means is prepared for every controller to add the ID information showing an identification code to the photographing start signal and to transmit them. Then the device receives the signals from the controllers to perform photographing and at the same time adds the received ID information to the fetched image information together with the photographing start signals to record them at a storage part. The image information acquired by the device are transferred to a data server. Then a desired image is extracted in response to a user request and based on the ID information, outputted to a display device, printed or written into a recording medium.”

### SUMMARY OF THE INVENTION

When a user wants to take pictures away from home or outdoors, the user carries a camera. And, when the user wants to take pictures, the user takes out the camera and shoots them. When the user stays for a long term away from home, the user also carries a spare film and battery together with the camera for exchange, as necessary.

As digital cameras spread widely in these years, a recording medium has been changed from a bulky roll of film to a thin, small memory card. In addition, since the photographed data can be erased, the user can erase undesirable photographed data selected by the user, thus avoiding wasteful use of the memory capacity.

However, as an image sensor in a digital camera is advanced and the number of pixels is remarkably increased, the amount of photographed data to be processed has been increased and thus the power consumption of the camera has been increased. Since this requires a large battery capacity, the weight of the camera correspondingly increases. In order to improve a picture quality and telescoping function, further, its optical system is required to be large in size, which demands a large camera casing. In facilities such as an amusement park, since the user carries such a camera for a long time, the heavy and large-sized camera becomes cumbersome for the user to handle with.

Meanwhile, in the invention disclosed in the above Publication, all image data acquired by the camera device are transferred to the data server, so that, in a large-scaled theme park having many visitors, the data server requires a very large recording medium capacity. Further, when stored image data is looked at, printed or the like, many users make access to the data server at the same time, in particular, at the time of closing the theme park, with the result that a load imposed on the data server or network becomes very high. Thus, there still remain such problems in the invention of the above Publication.

It is an object of the present invention, in view of the problems in the prior art, to provide a camera system wherein a user can obtain a high quality of picture easily in facilities such as an amusement park and which can lighten a load imposed on a server or network.

The above object is attained by the inventions set forth in an item ‘WHAT IS CLAIMED IS’. In an embodiment of the present invention, a camera is installed at a photographing spot or the like in facilities, a server is installed in a management room or the like in the facilities, a terminal apparatus is installed at a rest room in the facilities, and a portable device is lent to a user at the entrance gate of the facilities. In this case, the user carries the portable device, takes pictures using the camera at the photographing spots or the like. The photographed data are stored in the server and/or portable device so that the user can look at the pictures on the terminal apparatus installed in the rest room or the like. For details, see an item ‘DETAILED DESCRIPTION OF THE EMBODIMENTS’.

### BRIEF DESCRIPTION OF THE DRAWINGS

These and other features, objects and advantages of the present invention will become more apparent from the following description when taken in conjunction with the accompanying drawings wherein:

FIG. 1 is a block diagram of a camera system in accordance with a first embodiment of the present invention;

FIG. 2 is a flow chart of the camera system of the first embodiment of the present invention;

FIG. 3 is a block diagram of a camera system in accordance with a second embodiment of the present invention;

FIG. 4 is a flow chart of the camera system of the second embodiment of the present invention;

FIG. 5 is a block diagram of a camera system in accordance with a third embodiment of the present invention;

FIG. 6 is a flow chart of the camera system of the third embodiment of the present invention;

FIG. 7 is a block diagram of a camera system in accordance with a fourth embodiment of the present invention;

FIG. 8 is a flow chart of the camera system of the fourth embodiment of the present invention;

FIG. 9 is a block diagram of, a camera system in accordance with a fifth embodiment of the present invention;

FIG. 10 is a flow chart of the camera system of the fifth embodiment of the present invention;

FIG. 11 is another flow chart of the camera system of the first embodiment of the present invention; and

FIG. 12 is a further flow chart of the camera system of the first embodiment of the present invention.

### DETAILED DESCRIPTION OF THE EMBODIMENTS

Explanation will be made as to embodiments of the present invention, with reference to the accompanying drawings.

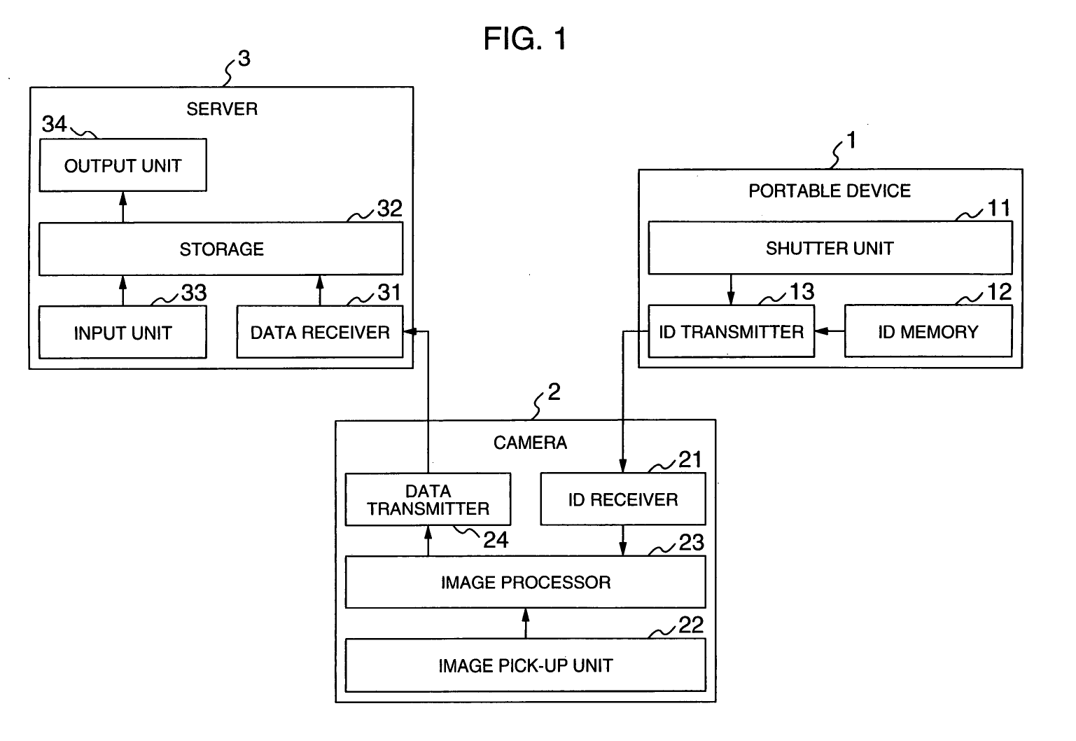

FIG. 1 shows a camera system in accordance with a first embodiment of the present invention. In FIG. 1, reference numeral 1 denotes a portable device to be carried by a user in facilities such as an amusement park, numeral 11 denotes a shutter unit such as a shutter button for determining timing of transmission of an identification (which will be referred to as the ID, hereinafter) identifying the portable device to a camera 2, which installed in the facilities, 12 denotes an ID memory for storing the ID therein, 13 denotes an ID transmitter for transmitting the ID to the camera, 21 denotes an ID receiver for receiving the ID transmitted from the portable device 1, 22 denotes an image pick-up unit such as a CCD or CMOS sensor, 23 denotes an image processor for subjecting the image data taken by the image pick-up unit 22 to image processing such as compression or noise processing to generate data including the ID received at the ID receiver 21 and the image data, 24 denotes a data transmitter for transmitting data generated at the image processor 23 to a server, 3 denotes a server for saving the data taken by the camera 2, 31 denotes a data receiver for receiving data transmitted from the data transmitter 24, 32 denotes a storage having a function of saving the data received at the data receiver 31 and a function of searching for image data using the ID as a search key, 33 denotes an input unit for the user to enter the ID to attain the taken image data, and 34 denotes an output unit such as a display or display drive for outputting the image data obtained by the user who searched the storage 32 with use of the ID entered from the input unit 33 as the search key.

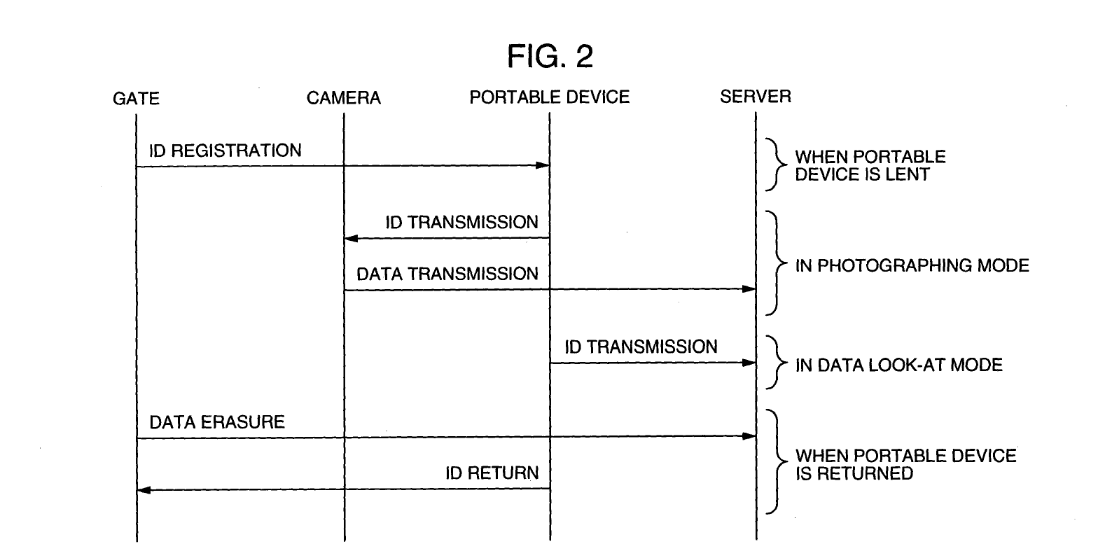

FIG. 2 is a flow chart of the camera system in accordance with the first embodiment of the present invention, showing flows of data between a gate, the camera 2, the portable device 1 and the server 3 at the time of lending the portable device, taking a picture, looking at data and returning the portable device.

The operation of the first embodiment of the present invention will be explained by referring to FIG. 1. However, it is assumed, when the user uses the portable device 1, that the ID is already registered in the portable device 1 at a gate or a similar place in the facilities and also previously stored in the ID memory 12.

First of all, the user determines photographing timing at the shutter unit 11 of the portable device 1. The shutter unit 11, when the shutter timing is determined, issues an instruction to the ID transmitter 13 to transmit the ID to the camera 2. The ID transmitter 13 in turn reads out the ID stored in the ID memory 12 and transmits the ID to the ID receiver 21 of the camera 2 in a wireless communication manner or wirelessly. The wireless communication means includes Standards such as IEEE802.11 and Bluetooth. The ID receiver 21 of the camera 2 receives the ID from the ID transmitter 13, sends the ID to the image processor 23. The image processor 23 in turn issues an instruction to the image pick-up unit 22 to take a picture thereby. The image pick-up unit 22 sends image data taken by the image pick-up unit to the image processor 23. The image processor 23 then generates data containing the image data from the image pick-up unit 22 and the ID, and issues an instruction to the data transmitter 24 to transmit the data from the data transmitter to the server 3. The data transmitter 24, when receiving the instruction, transmits the data to the data receiver 31 of the server 3. The 31 of the server 3 sends to the storage 32 the data received from the data transmitter 24 to save the data as a key for management of the ID.

When the user wants to look at the taken image data or move the image data to a medium such as an optical disk or memory card, the user enters the ID identifying the portable device from the input unit 33 of the server 3. The input unit 33 in turn sends the entered ID to the storage 32, the storage 32 in turn searches for the image data with use of the ID as a search key, and sends the searched image data to the output unit 34 such as a display or display drive. The output unit 34 displays the received image data or writes the data in a medium.

In this way, when the user wishes to take pictures, he is only required to carry the portable device alone. And since the camera is installed in the facilities, the user can use the high-quality, high-level-of-function camera regardless of the size and weight of the camera, and can take pictures without concern for the save capacity because the taken image data is saved in the server. As a result, in facilities such as an amusement park, the user can easily obtain a high quality of picture.

When a function of determining timing of transmitting the ID at intervals of constant time is provided to the shutter unit 11, the user can take a snapshot of his or her natural expression without paying any attention to the camera. In this case, a wireless communication turning-off means or a power turning-off means can be added to the portable device 1, so that, if the user does not want to be shot, then these means are used not to transmit the ID to the camera.

Further, when a function of, e.g., generating data containing a time when receiving the ID or position information about the camera 2 is provided to the image processor 23 of the camera 2 and when the ID, photographed data, the ID reception time, the position information of the camera 2, file name, etc. are saved in the server; the user can facilitate his rearranging works of the photographed data or his editing of the album if he wants to do so.

Furthermore, the portable device 1 may be lent to the user under the conditions that the portable device should be used only in the facilities and that, if the user wants to go out of the facilities, then the user should return the portable device 1. In this connection, the portable device 1 may be equipped with a means for issuing an attention or alarm sound to the user who tries to take out the portable device 1 outside the facilities.

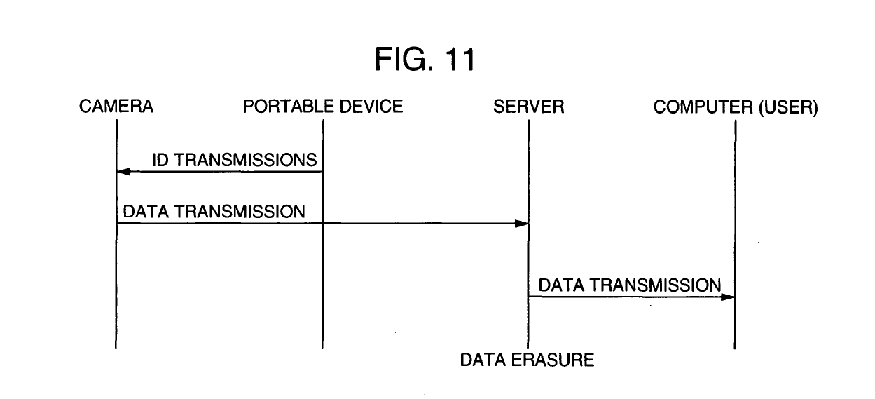

Though not illustrated in FIG. 1, a function of connecting the server 3 to the Internet may be provided to the server 3, the IP address of a computer installed in user's home may be previously set in the server 3, so that, after the user's photographed data is transmitted from the camera 2 to the server 3, the server 3 can automatically transmit the photographed data to user's home computer. Flows of data in the photograph mode in the above case are shown by a flow chart in FIG. 11. As a result, such a situation can be avoided that many users make access to the server 3 at the same time even as the amusement park gets closer to its closing time, that is, the load of the server 3 can be lightened. Further, since user's photographed data is immediately transmitted to user's computer, the user can delete the transmitted photographed data from the server 3 and thus the capacity of the storage 32 can be saved.

Further, not the user's computer but a briefcase service offered by an existing Internet provider may be used to transmit the photographed data to the Internet briefcase registered by the user.

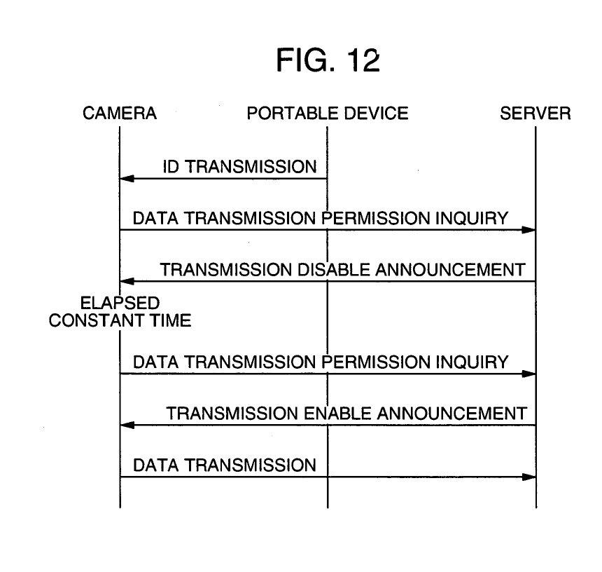

In addition, such an arrangement may be allowed that bidirectional communication is established between the data transmitter 24 and data receiver 31, a memory (not shown) is provided in the camera 2, and the camera 2 performs communication to know whether or not the camera 2 can transmit the photographed data to the server 3. If the camera can transmit the data, then the server 3 informs the camera 2 of the effect as its communication response, after which the camera 2 transmits the photographed data to the server 3. If the camera cannot transmit the data, then the photographed data is temporarily held in the not shown memory of the camera 2 and, after passage of a predetermined time, the camera 2 again communicates with the server 3. The server 3 informs the camera 2 of the impossible-transmission fact, and thereafter the server 3 performs transmission scheduling management. Flows of data in the photograph mode in the above case are shown by a flow chart in FIG. 12. With such an arrangement, the congestion or concentration of transmission of photographed data can be relieved and thus the load of the network can be lightened.

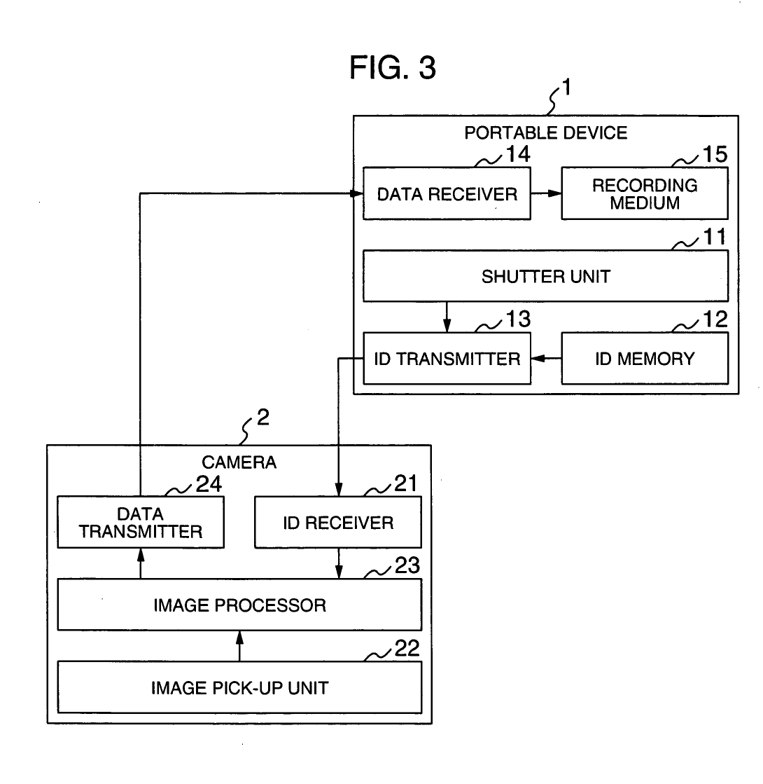

FIG. 3 shows a camera system in accordance with a second embodiment of the present invention. In FIG. 3, units having the same functions as those in FIG. 1 are denoted by the same reference numerals. In the drawing, reference numeral 14 denotes a data receiver for receiving data from the camera 2, and numeral 15 denotes a recording medium for storing the data received at the data receiver 14. The present embodiment is different from the first embodiment in that the data transmitter 24 of the camera 2 transmits data generated at the image processor 23 to the data receiver 14 of the portable device 1 and that the server 3 is not provided, and is substantially the same as the first embodiment in the other operations and thus explanation thereof will be omitted.

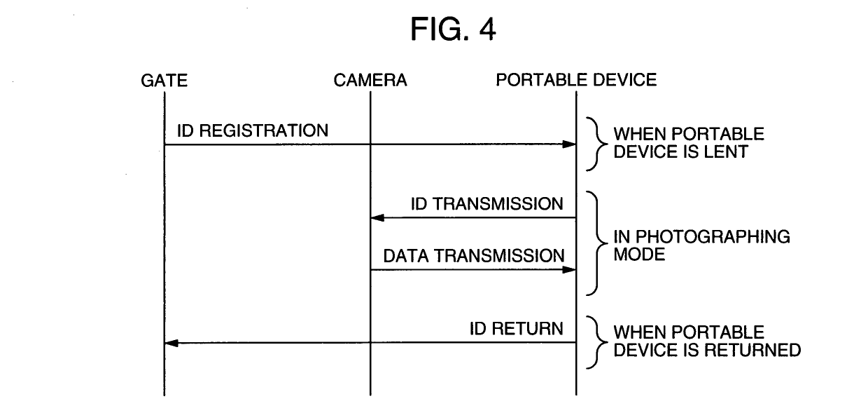

FIG. 4 shows a flow chart for explaining the operation of the camera system of the second embodiment of the present invention. FIG. 4 shows flows of data between the facility gate, camera 2 and portable device 1 when the portable device is lent, in the photograph mode, and when the portable device is returned.

In the second embodiment, since the need for the server 3 and a network between the camera 2 and server 3 can be eliminated, the camera system can be formed with a low cost and the user can easily take pictures using the camera.

Further, when the portable device 1 is equipped with an additional user interface function so that the user can display or delete data saved in the recording medium 15, the capacity of the recording medium can be effectively utilized.

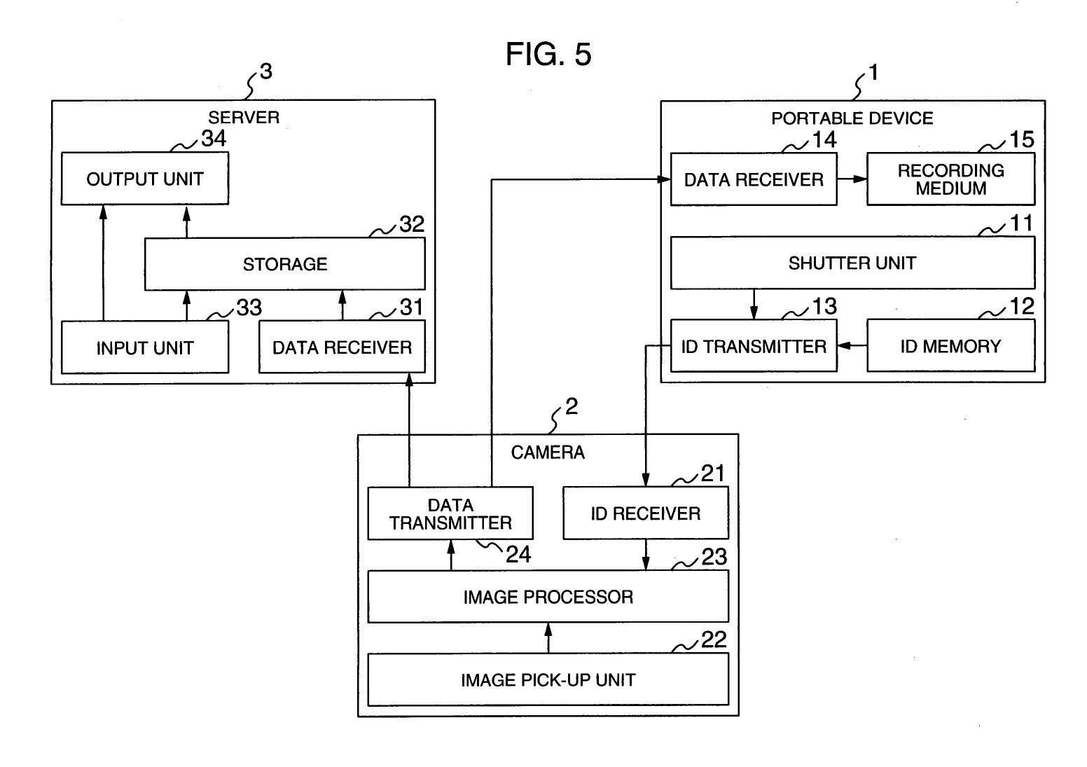

FIG. 5 shows a camera system in accordance with a third embodiment of the present invention. In FIG. 5, units having the same functions as those in FIGS. 1 and 3 are denoted by the same reference numerals. In the present embodiment, the image processor 23 has a function of generating data including image data with two sorts of resolutions, that is, first data to be saved in the server 3 and second data to be saved in the recording medium 15 of the portable device 1 and having a resolution lower than that of the data to be saved in the server 3. The data transmitter 24 has a function of transmitting the first data to the data receiver 31 of the server 3 and transmitting the second data to the data receiver 14 of the portable device 1. The input unit 33 of the server 3 has functions of reading out data from the recording medium of the portable device 1, and transmitting the recorded contents of the recording medium to the output unit 34. In the third embodiment, when the user wishes to look at image data taken by the user, the user inputs the data of the recording medium 15 of the portable device 1 from the input unit 33 of the server 3, and the input unit 33 in turn reads out the second data recorded in the recording medium 15 and having the lower resolution and outputs it to the output unit 34 for its display. The means for inputting the data of the recording medium 15 to the input unit 33 includes a method for dismounting the removable recording medium 15 from the portable device 1 and inserting the medium into the input unit 33 and a method for communicating with the input unit 33 with the recording medium 15 being fixed in the portable device 1. When the user wants to confirm the focused image or picture quality, the user issues an instruction to the storage 32 to search the storage 32 with use of the ID or second data as a search key, and the storage 32 in turn outputs its searched result to the output unit 34. The other operations of the third embodiment are substantially the same as those of the first embodiment, and thus explanation thereof is omitted.

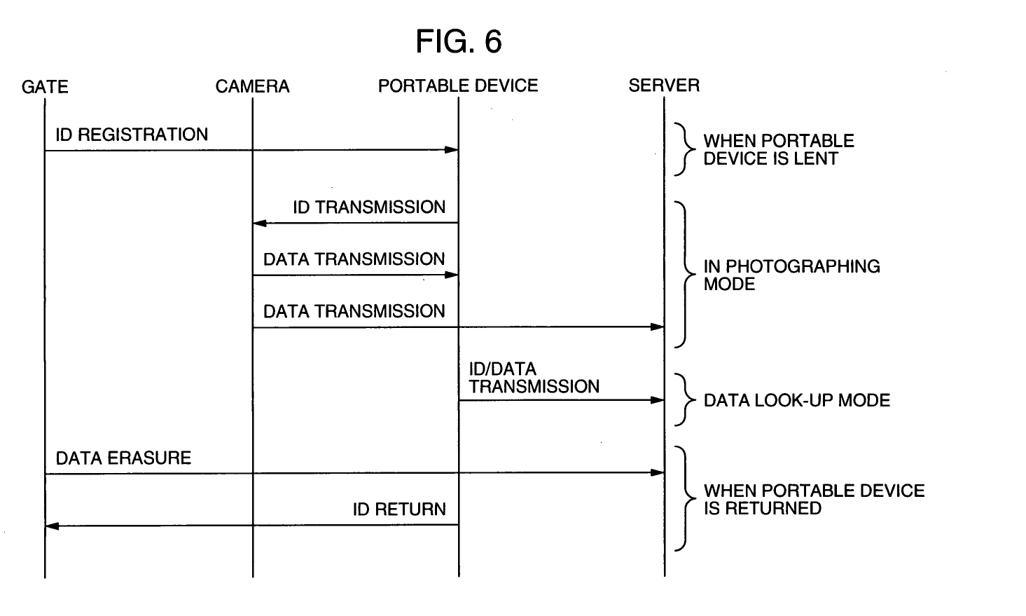

FIG. 6 is a flow chart for explaining the operation of the third embodiment of the present invention. FIG. 6 shows flows of data between the facility gate, camera 2, portable device 1, and server 3, when the portable device is lent, in a photograph mode, when data is looked at, and when the portable device is returned.

In the third embodiment, since photographed data is recorded in both of the server 3 and portable device 1, the storage 32 is less frequently searched when the user looks at the photographed data, and thus the operation thereof becomes light.

When the portable device 1 is equipped with a user interface function so that data saved in the recording medium 15 can be displayed or deleted, further, the capacity of the recording medium can be effectively used. When the contents of the recording medium 15 is input to the input unit 33, if the contents of the recording medium 15 is arranged to be automatically synchronized with the contents of the storage 32, then the portable device 1 is regarded virtually as a terminal of the server 3 and thus the need for the user to go to the installation place of the server 3 for the purpose of delete images can be eliminated.

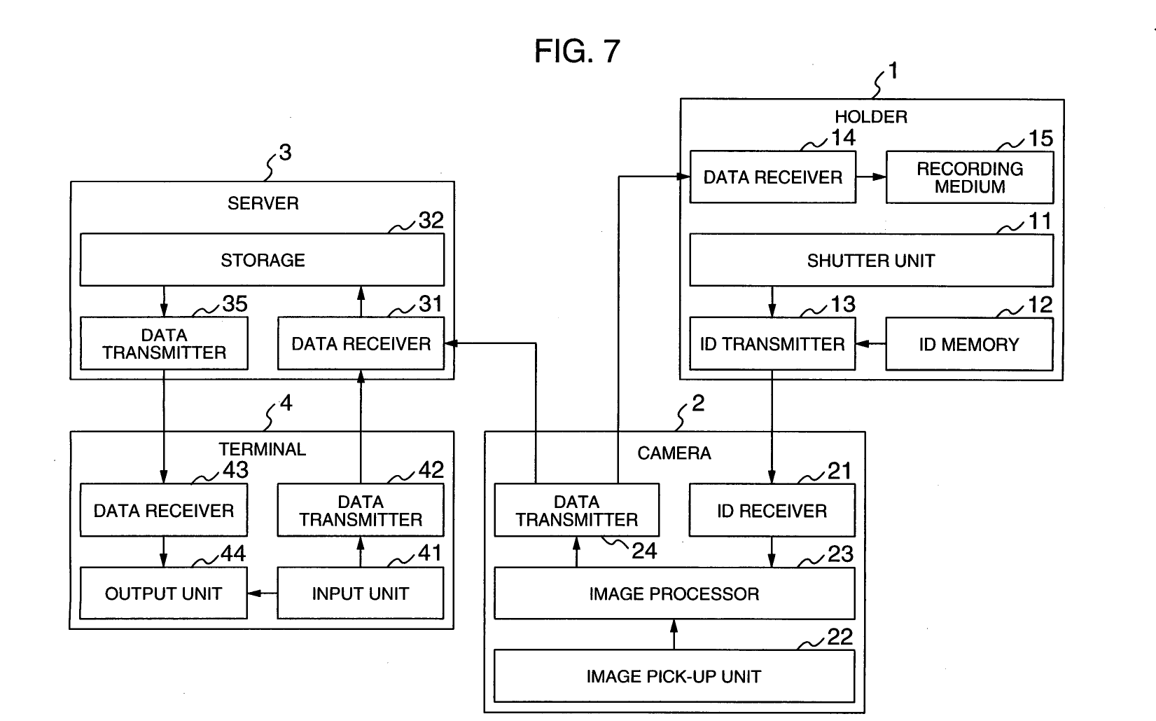

FIG. 7 shows a camera system in accordance with a fourth embodiment of the present invention. In FIG. 7, units having the same functions as those in FIGS. 1 to 5 are denoted by the same reference numerals. In the present embodiment, reference numeral 4 denotes a terminal which is used by the user to access the server 3. Numeral 41 denotes an input unit for the user to enter the ID, numeral 42 denotes a data transmitter for transmitting the ID entered from the input unit 41 to the server 3, 43 denotes a data receiver for receiving image data as a result searched in the server 3, and 44 denotes an output unit for displaying image data received at the data receiver 43 thereon or writing the data into a medium. The present embodiment is different from the first and third embodiments in that the data receiver 31 of the server 3 has functions of receiving data from the data transmitter 24 of the camera 2 and receiving data from the data transmitter 42 of the terminal 4, and that a data transmitter 35 for transmitting image data searched by the storage 32 to the data receiver 43 of the terminal 4 is newly provided.

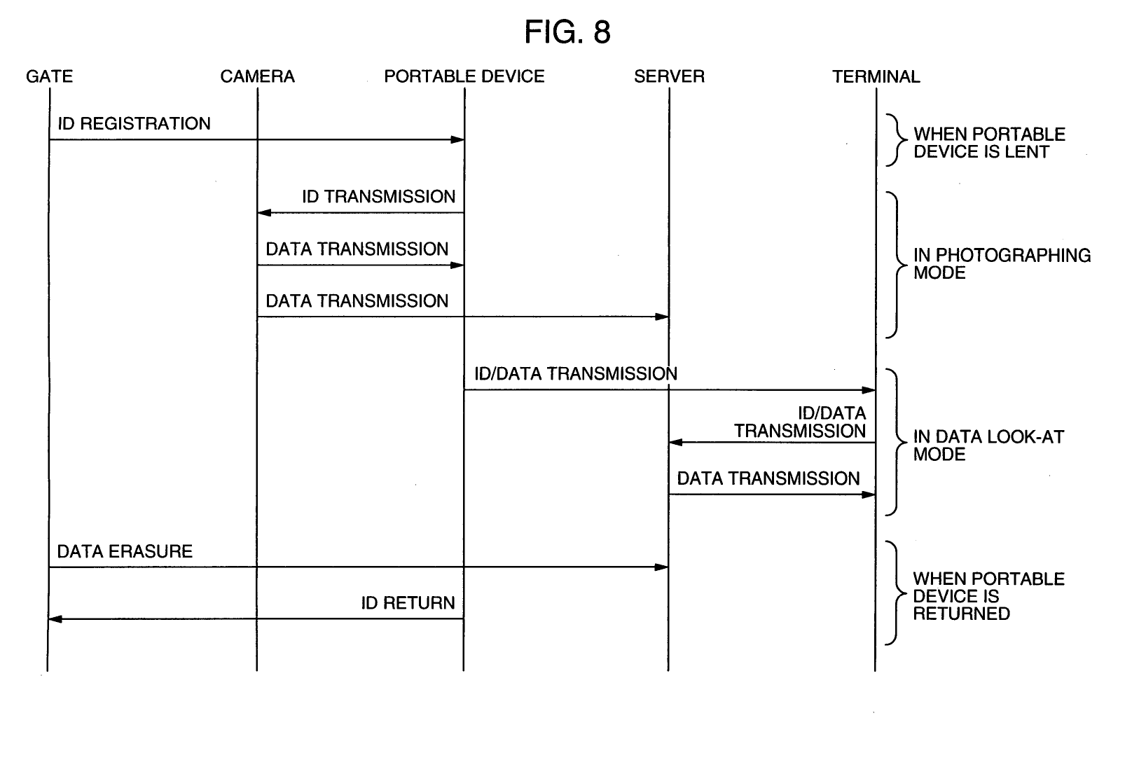

FIG. 8 is a flow chart for explaining the operation of the camera system of the fourth embodiment of the present invention, showing flows of data between the facility gate, camera 2, portable device 1, server 3 and terminal 4, when the portable device is lent, in a photograph mode, when the user looks at data and when the user returns the portable device.

The fourth embodiment is different in the operation when the user looks at photographed image data. The user makes access to the server 3 from the terminal 4 installed in the facilities. The user enters the data of the recording medium 15 of the portable device 1 from the input unit 41, the input unit 41 reads out the second data recorded in the recording medium 15 and having the lower resolution, and sends the read-out data to the output unit 44 to display the data thereon. The means for entering the data of the recording medium 15 into the input unit 41 includes a method for dismounting the removable recording medium 15 from the portable device 1 and inserting the medium into the input unit 41 and a method for communicating with the input unit 41 with the recording medium 15 being fixed in the portable device 1. When the user wishes to confirm the focused image or picture quality, the input unit 41 sends data including the ID and the second data to the data transmitter 42, the data transmitter 42 in turn sends the data to the data receiver 31 of the server 3, the data receiver 31 in turn sends the data to the storage 32, the storage 32 in turn performs searching operation with use of the ID or second data in the received data as a search key and sends its searched result to the data transmitter 35, the data transmitter 35 in turn sends the searched result to the data receiver 43 of the terminal 4, and the data receiver 43 in turn outputs the searched result to the output unit 44.

In this way, when the server 3 and terminal 4 establishes a network, a plurality of users can confirm photographed data at the same time, thus lightening even the load of the server 3.

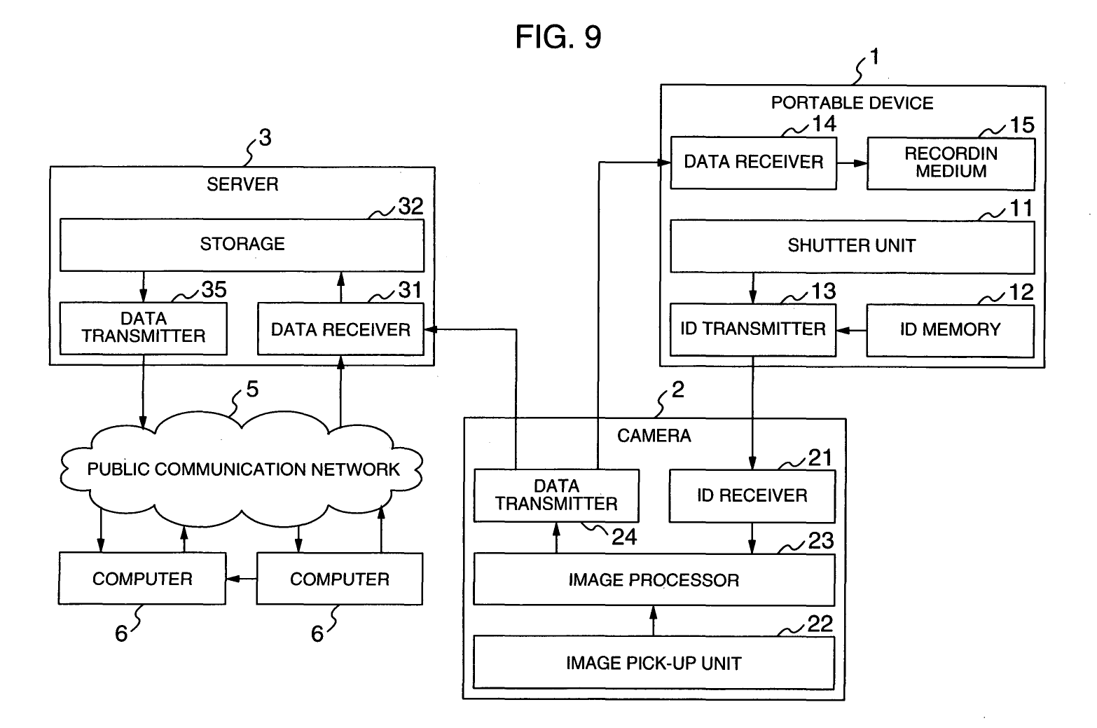

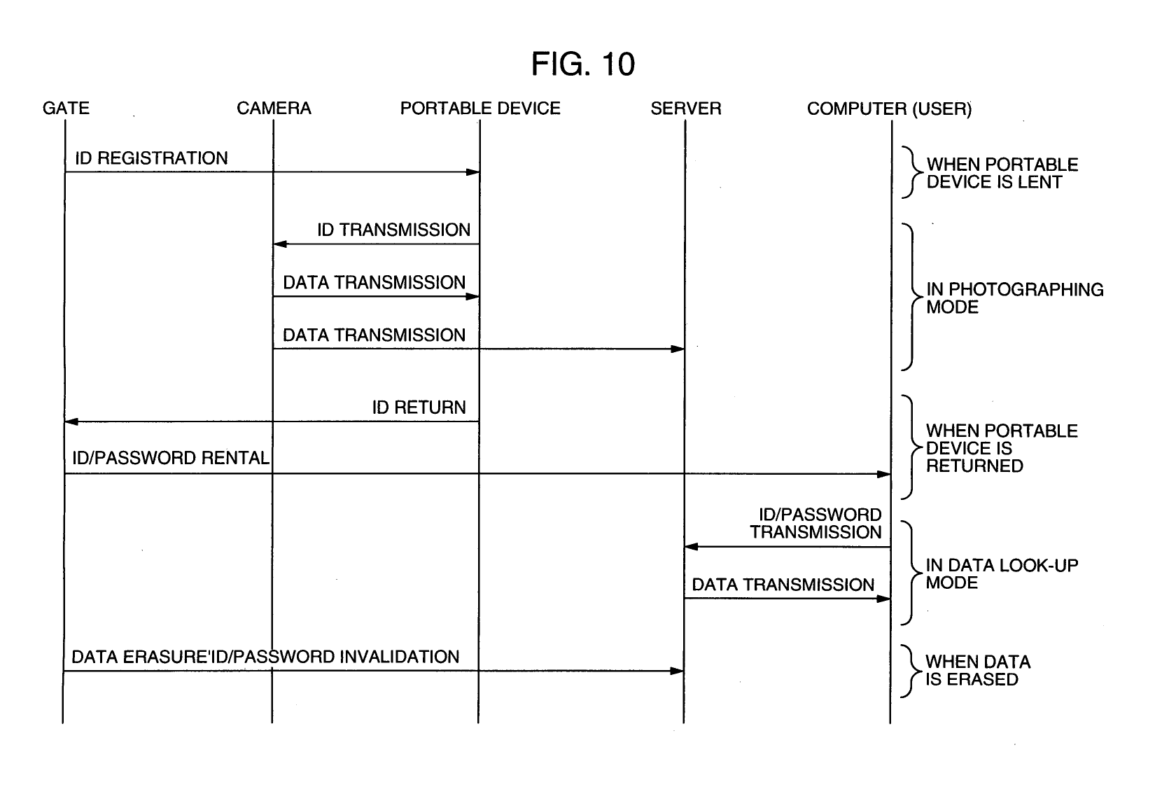

FIG. 9 shows a camera system in accordance with a fifth embodiment of the present invention. In FIG. 9, units having the same functions as those in FIGS. 1 to 7 are denoted by the same reference numerals. In the present embodiment, reference numeral 5 denotes a public communication network such as telephone line, and numeral 6 denotes a computer possessed by the user. FIG. 10 is a flow chart for explaining the operation of the camera system of the fifth embodiment of the present invention. FIG. 10 shows flows of data between the facility gate, camera 2, portable device 1, server 3 and computer 6, when the portable device is lent, in a photograph mode, when the user returns the portable device, when the user looks at data and in a data erasure mode.

The fifth embodiment is different from the fourth embodiment in the operation when the user looks at photographed image data. An ID and a password are previously given to the user, and the user accesses the server 3, for example, using a WWW browser to look at the photographed image data. The given ID may be the same as an ID for identifying the portable device or may be another new ID different therefrom. When the user wishes to look at the photographed image data, the user enters the ID and password from the computer 6. The computer 6 transmits the ID and password to the data receiver 31 of the server 3 via the public communication network 5. The data receiver 31, when receiving the ID and password, then sends them to the storage 32. The storage 32 in turn authenticates the ID and password. When the authentication is OK, the storage 32 searches for the photographed data with use of the ID as a search key, sends data as a searched result to the data transmitter 35. The data transmitter 35 then transmits the searched result data to the user's computer 6 via the public communication network 5. If the authentication is NO, then the storage 32 sends the authenticated result to the data transmitter 35, and the data transmitter 35 transmits the authenticated result to the computer 6 via the public communication network 5. The other operations are substantially the same as those of the fourth embodiment and thus explanation thereof is omitted.

In this way, the public communication network 5 and the user's computer 6 are used. Accordingly, even after the user left the facilities, the user can look at the photographed data.

In the first and third to fifth embodiments, since many users save their image data in the server 3, the storage 32 is required to have a large recording capacity. To avoid this, the storage 32 may be designed to set a limited reservation period and to erase data relating to an ID having an expired reservation period.

As has been explained in the foregoing, in accordance with the present invention, there can be provided a camera system wherein a user can easily obtain a high quality of pictures in facilities such as an amusement park and the loads of a server and network are light.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications fallen within the ambit of the appended claims.

What is claimed is:

1. A camera system having a portable device and a camera, said portable device comprising:
a receiver unit to receive image data photographed by the camera;
a writer unit to write the received image data in a memory medium;
a memory unit to store an ID for identification of the portable device; and
a transmitter unit to transmit the ID to the camera,
said camera comprising:
a receiver unit to receive the ID from the portable device;
an image pick-up unit to start image pick-up operation when receiving the ID; and
a transmitter unit to transmit the photographed image data to the portable device.

2. The camera system as set forth in claim 1, wherein a server is provided, said transmitter unit of the camera transmits said photographed image data and said ID to the server, and the server receives said image data and said ID from said camera and stores said data and ID as associated with each other.

3. The camera system as set forth in claim 2, wherein a terminal apparatus is provided, said terminal apparatus includes an input unit to enter an ID for identifying said portable device, a transceiver unit to transmit the entered ID to said server and to receive image data from said server, and an output unit to output the received image data, and said server includes a transceiver unit to receive the ID for identifying said portable device from the terminal apparatus and to transmit image data to the terminal apparatus, and a search unit to search for the image data on the basis of the received ID.

4. The camera system as set forth in claim 2, wherein said server includes a transceiver unit to receive said ID and a password corresponding to the ID from a computer connected via a network and to transmit said image data corresponding to said ID via the network to the computer and an analyzer unit to analyze said ID and password and to judge whether or not to transmit said image data corresponding to said ID.

5. The camera system as set forth in claim 2, wherein said camera includes a unit to generate other image data having a resolution lower than a resolution of said photographed image data and to transmit said photographed image data to said server and to transmit the other image data having the lower resolution to said portable device.

6. A camera system having a portable device and a server, said portable device comprising:
a memory unit to store an ID for identification of the portable device; and
a transmitter unit to transmit the ID to the camera,
said camera comprising:
a receiver unit to receive the ID from the portable device;
an image pick-up unit to start its image pick-up operation when receiving the ID; and
a transmitter unit to transmit the ID and the photographed image data to the server,
said server comprising:
a receiver unit to receive the ID and the image data from the camera;
a memory unit to store information indicative of the ID and a transmission destination of the image data corresponding to the ID; and
a transmitter unit to transmit the received image data to the transmission destination.

7. The camera system as set forth in claim 6, wherein said camera includes a memory unit to store said image data therein and, before transmitting said image data to said server, stores said image data in the memory unit and, after receiving a transmission permission from said server, transmits said image data to said server, and wherein said server issues the transmission permission to said camera according to predetermined conditions.

8. The camera system as set forth in claim 1, wherein said portable device includes a shutter unit which indicates timing to be photographed and transmits said ID to said camera according to the indication of the timing to be photographed.

9. The camera system as set forth in claim 1, wherein said portable device transmits said ID to said camera at intervals of a constant time.

10. A portable device in a camera system having the portable device and a camera, comprising:
a memory unit to store an ID for identification of the portable device;
a transmitter unit to transmit the ID to the camera;
a receiver unit to receive image data taken by the camera according to the ID; and
a write unit to write the received image data in a memory medium.

11. A camera in a camera system having a portable device and the camera, comprising:
a receiver unit to receive an ID for identification of the portable device;
an image pick-up unit to start image pick-up operation when receiving the ID; and
a transmitter unit to transmit the photographed image data in such a manner that the portable device writes the photographed image data in a memory medium.

12. A server in a camera system having a portable device, a camera and the server, comprising:
a receiver unit to receive image data taken by the camera and the ID according to an ID for identification of the portable device received from the portable device;
a memory unit to store the ID and information indicative of a transmission destination of the image data; and
a transmitter unit to transmit the received image data to the transmission destination.

13. An image pick-up method in a camera system having a portable device and a camera, comprising the steps of:
receiving an ID for identification of the portable device from the portable device;
starting image pick-up operation when the camera receives the ID; and
transmitting photographed image data from the camera to the portable device in such a manner that the portable device writes the photographed image data in a memory medium.

14. An image pick-up method in a camera system having a portable device, a camera and a server, comprising the steps of:
receiving an ID for identification of the portable device from the portable device by the camera;
starting an image pick-up operation of the camera when the camera receives the ID;
transmitting photographed image data to the portable device from the camera in such a manner that the portable device writes the photographed image data in a memory medium;
transmitting the photographed image data and said data from the camera to the server;
receiving the image data transmitted from the camera by the server; and
storing the received image data and the ID as associated with each other in the server.

15. An image pick-up method in a camera system having a portable device, a camera and a server, comprising the steps of:
receiving an ID for identification of the portable device by the camera;
starting an image pick-up operation of the camera when receiving the ID;
transmitting the photographed image data and the ID from the camera to the server;
receiving the image data and the ID transmitted from the camera by the server; and
transmitting the received image data from the server to a transmission destination corresponding to the received ID.

16. The camera system as set forth in claim 6, wherein said portable device includes a shutter unit which indicates timing to be photographed and transmits said ID to said camera according to the indication of the timing to be photographed.

17. The camera system as set forth in claim 6, wherein said portable device transmits said ID to said camera at intervals of a constant time.
